(19) United States
(12) Patent Application Publication
(10) Pub. No.: US 2013/0112368 A1
(43) Pub. Date: May 9, 2013

(54) GEOTHERMAL WELL LOOP

(71) Applicant: American Refining Group, Inc., Conshokocken, PA (US)

(72) Inventor: Albert A. Koenig, Coatesville, PA (US)

(73) Assignee: American Refining Group, Inc., Conshohocken, PA (US)

(21) Appl. No.: 13/666,585

(22) Filed: Nov. 1, 2012

Related U.S. Application Data
(60) Provisional application No. 61/555,038, filed on Nov. 3, 2011.

(51) Int. Cl. F24J 3/08; B23P 19/04

(52) U.S. Cl. 165/45; 29/428

(57) ABSTRACT

The present invention provides a continuous loop associated with a geothermal heat exchange system which, at once increases the heat transfer between the circulating water and the well bore by virtue of its larger surface area in contact with the bore (occupying a full 70% of the bore area), and yet at the same time is suitable for insertion into a bore in the earth.

### CROSS-REFERENCE TO RELATED APPLICATIONS

This application claims priority to U.S. Provisional Patent Application No. 61/555,038, filed Nov. 3, 2011, the entirety of which is hereby incorporated by reference.

### FIELD OF INVENTION

The present invention relates to geothermal wells, and more specifically to the loop configurations of geothermal wells.

The present invention relates to geothermal wells, and more specifically to the loop configurations used in geothermal wells.

### BACKGROUND OF THE INVENTION

Geothermal well systems are often used to provide heat exchange between a building's heating, cooling, and ventilation load and the earth. Efficient ground source heat pump operations have used vertical water wells since at least the 1980's. Most such systems incorporate a closed loop which employs high density polyethylene (HDPE) pipes grouted into a bore formed in the earth. While grouted loop systems offer relatively low maintenance over their lifetime, the initial installation cost can be substantial, impacting marketability.

Typically, 1″-1¼″ diameter HDPE pipes are used to form a loop located within a nominal 6″ diameter hole that has been previously bored into the earth. In such prior art designs, only about 40% of the surface area defined by the bore wall is occupied by the HDPE pipes. Further, the looped HDPE pipes will often contact each other within a single bore, allowing heat to be shunted between them. Thermal shunting between looped pipes affects the entire loop length, diminishing efficiency. U.S. Pat. No. 7,647,773 issued to Koenig addresses the problem of thermal shunting. Koenig provides a way to confine the loop in a central envelop commensurate with a 4″ pipe. The envelope is removed after installation, allowing the HDPE pipes to expand outwardly. However, Koenig does not address a solution to maximize surface area.

Published U.S. patent application Ser. No. 13/072,620, filed in the name of Hardin, discloses the use of a substantially kidney-shaped pipe to enable efficient heat transfer. Additionally, Hardin suggests that manufacturing costs may be reduced by extruding the pipes instead of molding it. Unfortunately, Hardin also suffers from several deficiencies. First, installation appears to be difficult and therefore costly, as the pipes in Hardin's geothermal well require fusion joints every 20 feet, and appear to require a crane on site for deployment. Further, the upcomer and downcomer pipes disclosed by Hardin appear to be consolidated in a single extrusion. This tends to increase thermal shunting and make it much more difficult to properly disperse grout into the borehole. It also appears that space is not used efficiently in Hardin. It is well known in the art that void space within the bore hole, after deployment of the pipe loop, diminishes efficiency in the geothermal system.

An improved geothermal well loop is needed that reduces the cost of installation while providing increased efficiency through reduction of thermal shunting while maximizing available surface area of the loop for the transfer of heat to the earth.

### SUMMARY OF THE INVENTION

The invention provides a loop which increases the heat transfer between water circulating in the loop and the earth by virtue of the loops larger effective outer surface area that is held in biased contact with the surface that defines the bore thereby engaging about seventy percent of the surface of the wall that defines the bore, and yet at the same time is suitable for easy insertion into the bore associated with a geothermal heat exchange system. The loop includes a first resilient pipe having a proximal end, a distal end and a first passageway that communicates between the proximal end and the distal end, a second resilient pipe having a proximal end, a distal end, and a second passageway that communicates between the proximal end and the distal end. A coupling elbow is positioned at the distal ends of the first and second resilient pipes. The coupling elbow defines a return passageway arranged so as to communicate between the first passageway and the second passageway of the resilient pipes. When the loop is positioned within the bore, the first resilient pipe and the second resilient pipe transition from (i) a bound state in which the first resilient pipe and the second resilient pipe are maintained in contact with one another to, (ii) a released state in which the first resilient pipe and the second resilient pipe are in biased contact with the surface extending into the earth that defines the bore. The biased contact of the pipes outer surfaces enhances heat transfer, while minimizing the possibility of shunting between the pipes.

In another embodiment of the invention, a geothermal heat exchange system is provided that includes a loop that is suitable for insertion into a bore formed by a surface extending into the earth. The bore has a proximal end and a distal end and the loop includes a first resilient pipe having a proximal end and a distal end and a first passageway that communicates between the proximal end and the distal end. A second resilient pipe is provided that has a proximal end and a distal end and defines a second passageway that communicates between the proximal end and the distal end. The first pipe and the second pipe are releasably bound to one another so as to be held in a preloaded state. A coupling elbow is positioned at the distal ends of the first and second resilient pipes. The coupling elbow provides a return passageway arranged so as to communicate between the first passageway and the second passageway. When the loop is positioned within the bore, the first resilient pipe and the second resilient pipe transition from the bound preloaded state to a released and unbound state in which the first resilient pipe and the second resilient pipe are in biased contact with the surface extending into the earth. The biased contact of the pipes outer surfaces enhances heat transfer, while minimizing the possibility of shunting between the pipes.

A method for locating a geothermal loop within a bore is provided that includes the steps of releasably binding a first resilient pipe to a second resilient together so as to preload the pipes, positioning the preloaded pipes within a bore in the earth, and unbinding the preloaded pipes so that each pipes springs away from the other pipe and into heat transfer engagement with the surface defining the bore.

### BRIEF DESCRIPTION OF THE DRAWINGS

These and other features and advantages of the present invention will be more fully disclosed in, or rendered obvious by, the following detailed description of the preferred embodiments of the invention, which are to be considered together with the accompanying drawings wherein like numbers refer to like parts and further wherein:

FIG. 1 is a partially broken away perspective view of a geothermal well loop formed in accordance with an embodiment of the invention;

FIG. 2 is a broken away perspective view of the geothermal well loop shown in FIG. 1;

FIG. 3 is a perspective view of a kidney-shaped pipe formed in accordance with an embodiment of the invention;

FIG. 4 is a perspective view of an elbow coupling fluid return formed in accordance with the present invention;

FIG. 5 is a perspective view of a bottom portion of a geothermal well loop formed in accordance with the present invention;

FIG. 6 is a cross-sectional view of the bottom portion of the geothermal well loop shown in FIG. 5, as taken along lines 6-6;

FIG. 7 is a perspective view of one apparatus employed for preparing and inserting a geothermal well loop into a bore formed in the earth;

FIG. 8 is a perspective view of a bore head having a geothermal well loop located within the bore;

FIG. 9 is a cross-sectional view of the geothermal well loop positioned within a bore, as taken along lines 9-9 in FIG. 8;

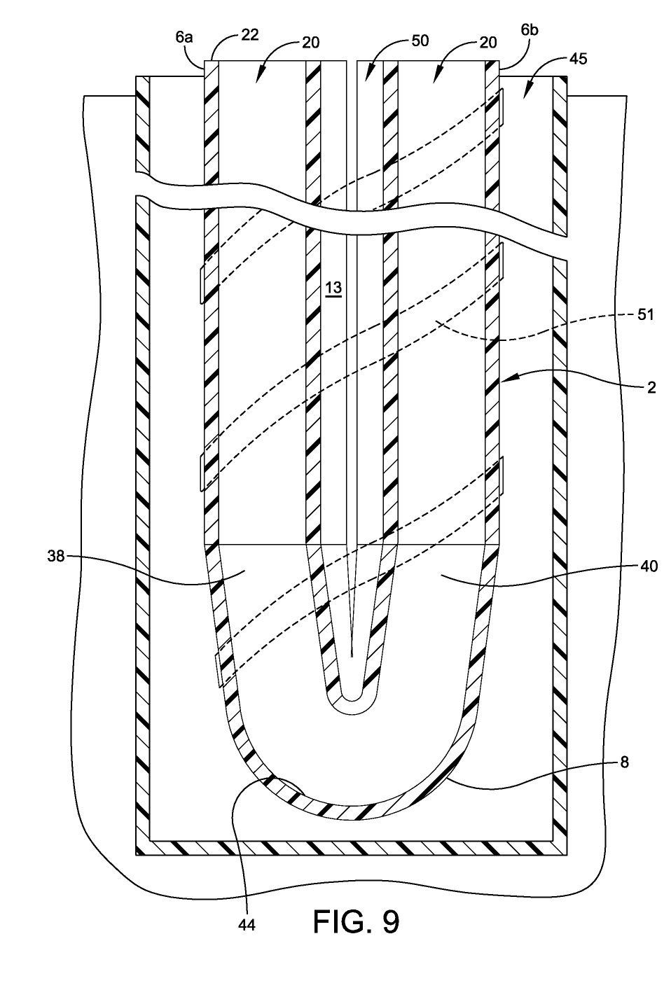

FIG. 10 is a cross-sectional view, similar to FIG. 9, but showing the introduction of water into the loop;

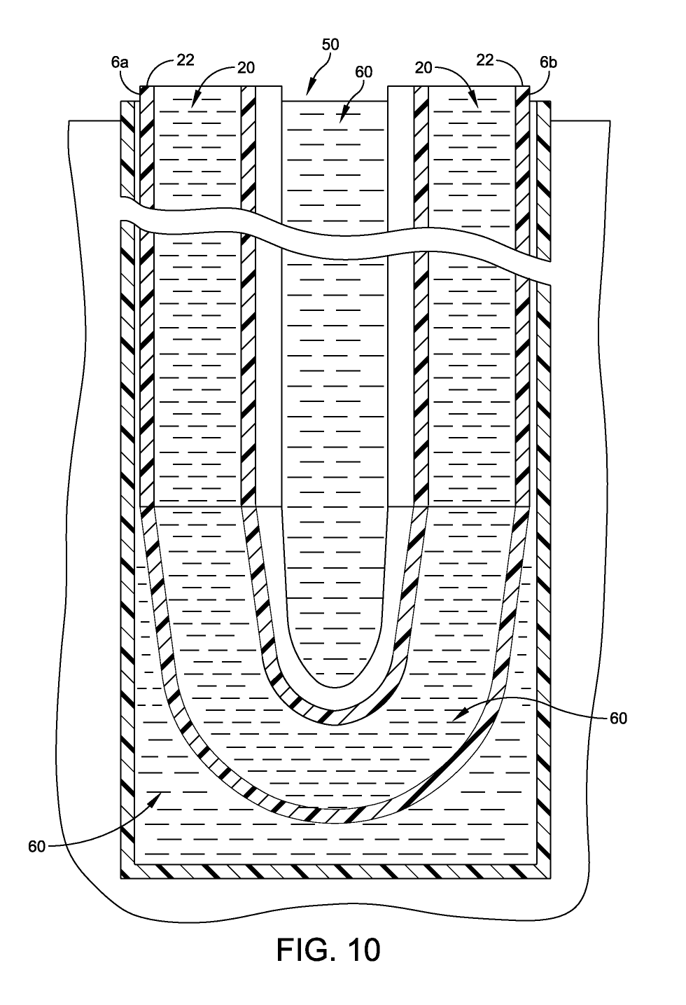

FIG. 11 is similar to FIG. 10, showing the grout solidified;

FIG. 12 presents an alternative an embodiment of pipe for use in connection with the present invention;

FIG. 13 is an exploded perspective view of the alternative embodiment of pipe shown in FIG. 12, arranged with the geothermal well loop disposed within a bore similar to that of FIGS. 8-11;

FIG. 14 is a perspective view of the alternative embodiment shown in FIG. 13 with the alternative pipes in place for use;

FIG. 15 is a cross-sectional view similar to FIG. 10, but showing liquid traversing an internal passage way of the geothermal well loop;

FIG. 16 is a broken away schematic view of a series of geothermal well loops interconnected in a parallel array in accordance with the present invention; and

FIG. 17 is a perspective view of a further embodiment of the invention including a circular cross-section return elbow.

### DETAILED DESCRIPTION OF THE PREFERRED EMBODIMENTS

This description of preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. In the description, relative terms such as “horizontal,” “vertical,” “up,” “down,” “top,” and “bottom” as well as derivatives thereof (e.g., “horizontally,” “downwardly,” “upwardly,” “rearwardly,” etc.) should be construed to refer to the orientations as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. In the claims, means-plus-function clauses, if used, are intended to cover the structures described, suggested, or rendered obvious by the written description or drawings for performing the recited function, including not only structural equivalents but also equivalent structures.

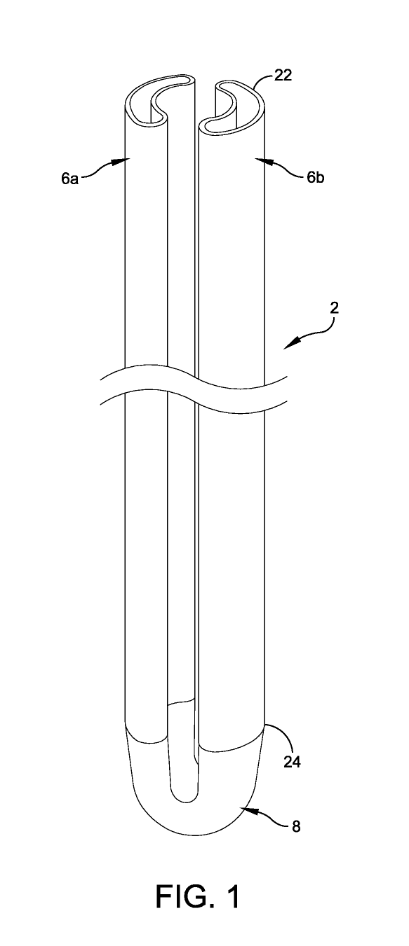

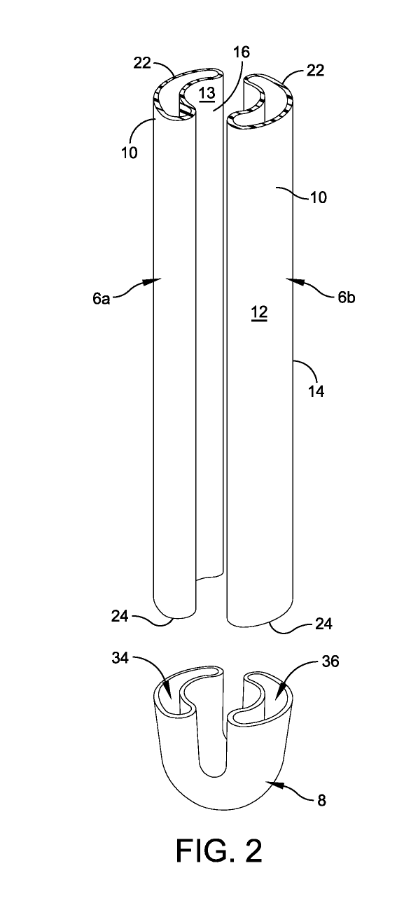

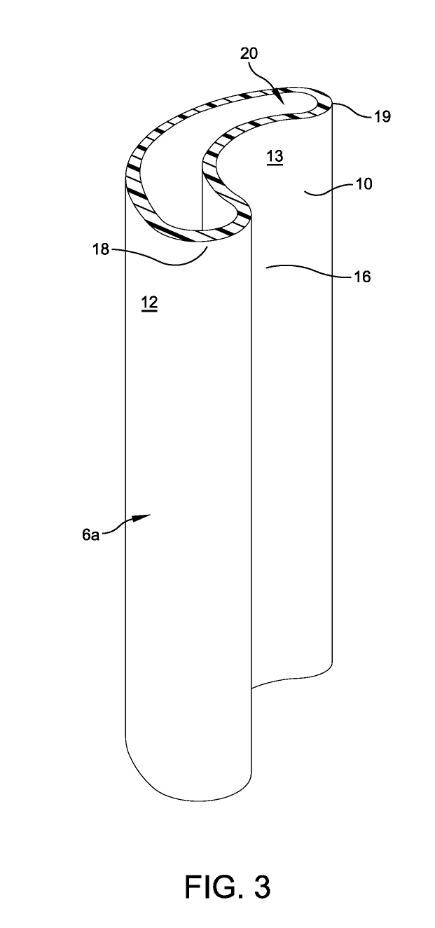

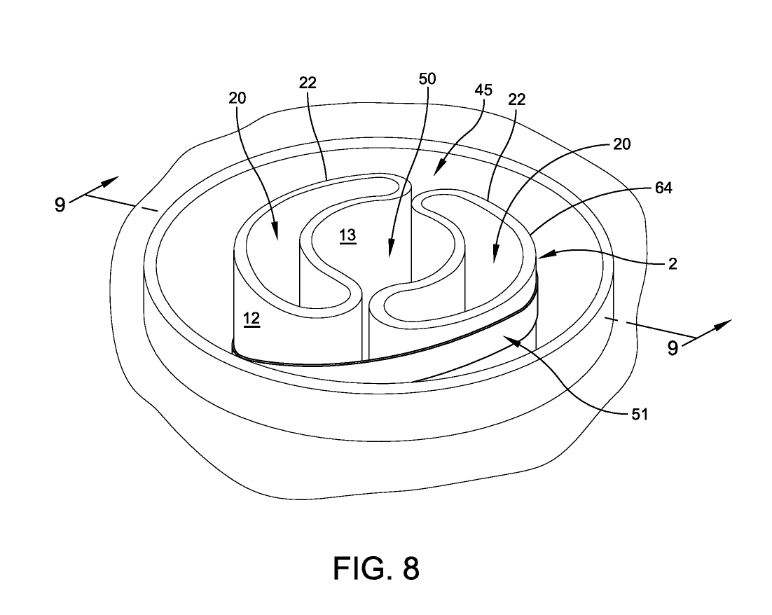

The invention offers various embodiments of a geothermal well loop 2 that provides efficient heat transfer when installed in a bore up to about 500′ deep. Referring to FIGS. 1-3, one embodiment of the invention includes a first kidney-shaped pipe 6a, a second kidney-shaped pipe 6b, and a return, coupling elbow 8. More particularly, each of kidney-shaped pipes 6a and 6b, has an elongate, continuous and resilient wall 10, with an outer surface 12 and an inner surface 13. Outer surface 12 of continuous wall 10 often includes radially outwardly disposed outer portion 14, a radially, inwardly disposed inner portion 16 which is often concentric with outer portion 14, a first side 18, and a second side 19. Continuous wall 10 defines a central passageway 20. Outer portion 14, inner portion 16, first side 18, and second side 19 are all often arcuate. The radius of curvature of outer portion 14 is typically greater than the radius of curvature of inner portion 16. The radii of curvature of the first and second sides 18, 19 are often equal, and may be smaller than the radii of curvature of outer and inner portions 14, 16. Inner surface 13 of continuous wall 10 extends continuously from a first end 22 to a second end 24 of each kidney-shaped pipe 6a and 6b, and defines a central passage way 50 of loop 2 (FIG. 8). In preferred embodiments, outer surface 12 is greater in surface area than inner surface 13 thereby enhancing the heat transfer characteristics of loop 2 when outer surface 12 is in biased contact with the wall of the bore. In one embodiment, kidney-shaped pipes 6a and 6b are extruded using a state-of-the-art HDPE material specification PE100/4710, which was developed to minimize the potential for cracking and to insure longevity in the ground. Rather than limit pipe lengths to nominally 20 foot sections, the pipe is extruded continuously and wound on a custom linear reel to a suitable length, typically less than 200 feet, as a tradeoff between the length required for the geothermal installation, and the ease of handling and transportation. The method of coiling imparts structural preloading so as to enhance the resilient characteristics of kidney-shaped pipe 6a and 6b, as will be more fully disclosed hereinbelow. Continuous wall 10 often has a uniform thickness of between about 0.125 inches and about 0.135 inches, with about 0.130 inches often being preferred for applications of the invention certified via 100 psi internal proof test. Importantly, continuous wall 10 is resilient at least in the sense that as a result of the coiling process during manufacturing, kidney-shaped pipe 6a and 6b is able to store elastic energy, when deformed or loaded, but retain a memory of the deformation imposed upon it during the reeling operation, thus providing a biased resilience which, during deployment, creates a spring effect against the wall of bore 45. In other words, kidney-shaped pipes 6a and 6b are able to store elastic energy as they are temporarily bound to one another in a substantially straight configuration for insertion into bore 45, but tend to spring apart quickly as the binding is removed.

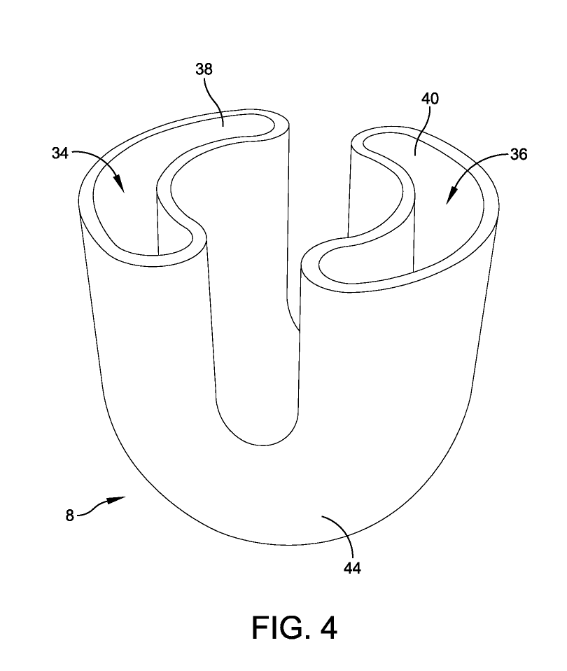

Referring to FIGS. 1-4, return coupling elbow 8 comprises an arc extending through approximately 180° so as to provide first and second consecutive right-angled turns at the terminal ends of kidney-shaped pipes 6a and 6b so as to couple them together to form loop 2. The arc of return coupling elbow 8 (FIG. 4) extends through a half circle in order to provide the approximately 180° angle. Return coupling elbow 8 includes a pair of ports 34 and 36, either of which may serve as an inlet or an outlet of return coupling elbow 8. These ports 34 and 36 communicate with a leg 38 which for the purposes of explanation will be considered an inlet leg, and a leg 40 which for the purposes of explanation will be considered an outlet leg. Legs 38 and 40 are connected by an arcuate channel 44, the outer surface of which is rounded so as to facilitate ingress of loop 2 into a bore formed in the earth. It is to be understood that leg 40 may serve as the inlet and leg 38 may serve as the outlet depending upon the orientation of return elbow 8.

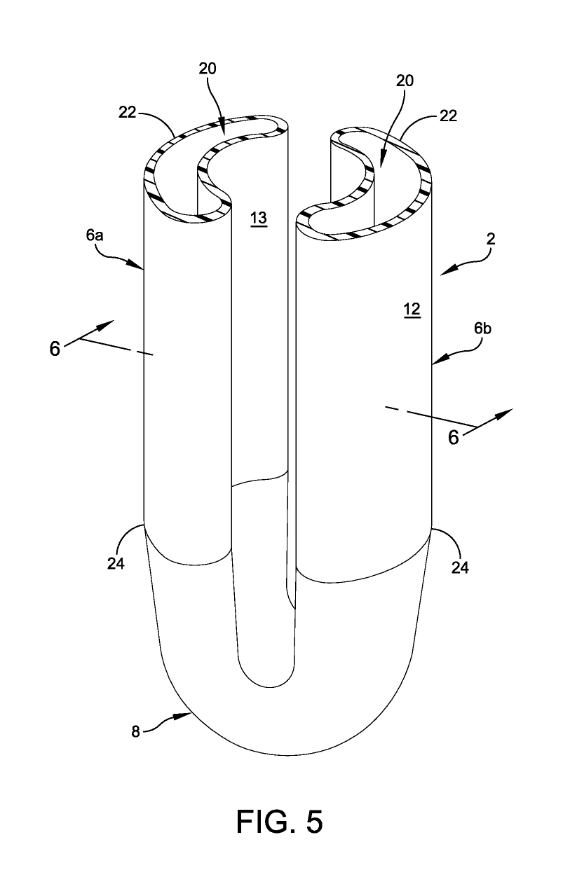

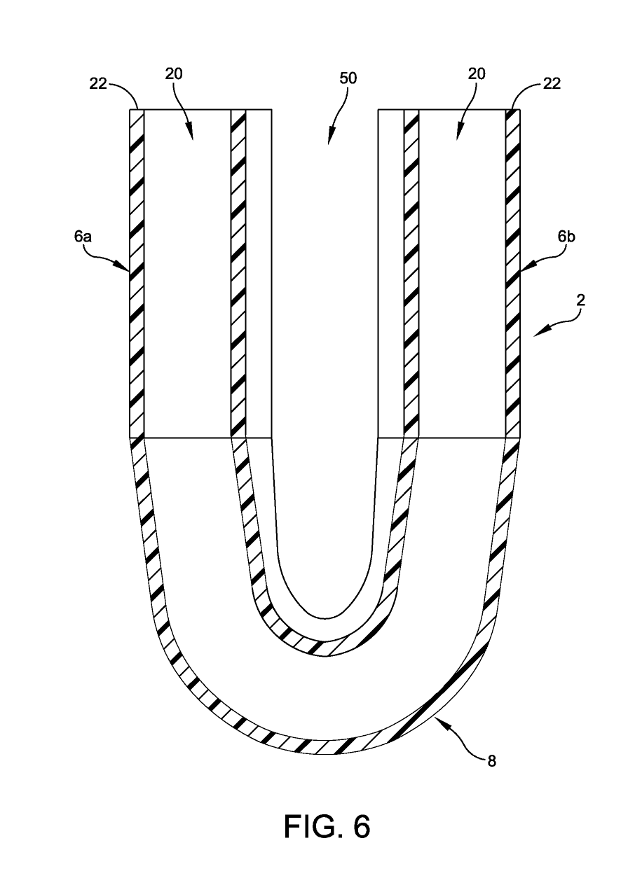

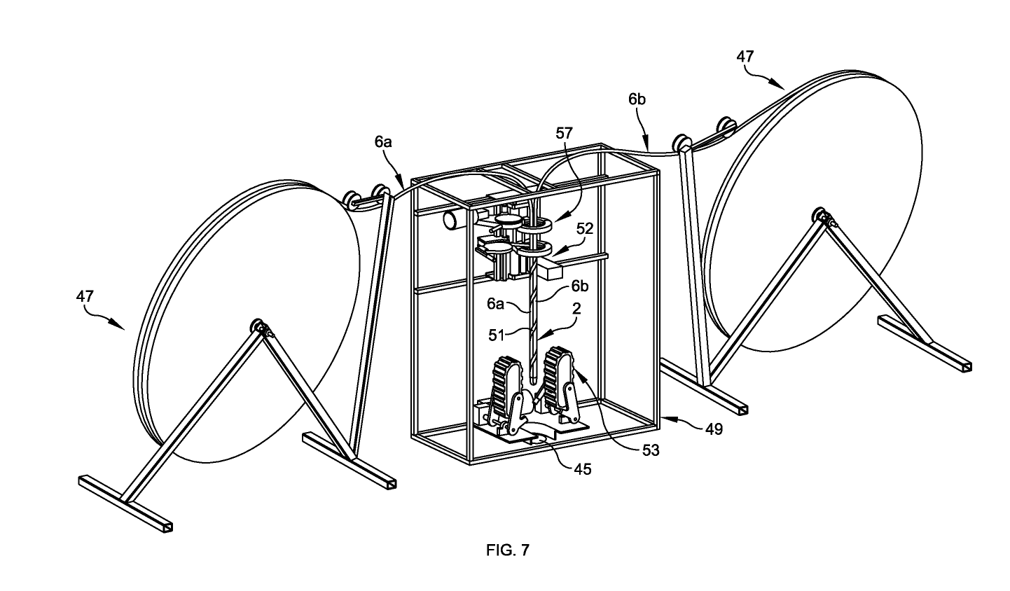

Referring FIGS. 5-7, geothermal loop 2 is often assembled while being installed into a bore 45. Reels 47, 49 hold up to 200 feet of linearly coiled kidney-shaped pipe. For the purpose of explanation kidney-shaped pipe 6a will be referred to as an “upcomer” pipe and kidney-shaped pipe 6b will be referred to as a “downcomer” pipe. Reel 47 houses upcomer pipe 6a, while reel 49 houses an downcomer pipe 6b. During manufacture, as the kidney-shaped pipe is extruded and partially cooled, it is linearly wound onto a factory coiler, similar to reels 47 and 49, such that a coil of increasing radius is deposited on the reel. The coiled product is then banded, removed from the factory coiler reel, and laid on a pallet for shipment. Significantly, when in position on reels 47, 49, first and second sides 18, 19 of each kidney-shaped pipe 6a, 6b project radially inwardly, with outer surface 12 of continuous wall 10 facing radially outwardly. As a consequence of coiling the kidney-shaped pipe with this orientation, the material of continuous wall 10 deforms plastically so as to adopt a curvature such that a preload bias is imparted to the now curved length of the kidney-shaped pipe. During deployment, reels 47, 49 are placed in approximately co-planar, confronting relation to one another adjacent to bore 45 so that kidney-shaped pipes 6a and 6b may be unwound simultaneously from opposing sides of bore 45. A stanchion 49 may be place atop bore 45 so as to gather, join, and direct the two lengths of kidney-shaped pipe during the insertion phase (FIG. 7).

More particularly, kidney-shaped pipes 6a, 6b are temporarily joined along their respective lengths prior to insertion into bore 45 so as to define passageway 50 between inner surfaces 13 of their respective inner portions 16 (FIG. 8). For example, kidney-shaped pipes 6a and 6b are often bundled and cinctured together with spiral wound frangible or dissolvable adhesive tape 51, e.g., paper or water-soluble adhesive coated plastic, just prior to entering bore 45. The spiral of tape 51 often has a long period, e.g., fifteen to twenty inches per full revolution about loop 2. Of course, kidney-shaped pipes 6a and 6b may also be joined with a water soluble glue of the type known in the art. Advantageously, the binding together of kidney-shaped pipes 6a and 6b with frangible tape 51 acts to overcome the residual outward bias inherent in the recently uncoiled kidney-shaped pipe such that the now taped and temporarily bound assembly stores elastic energy within the pipes, i.e., the tape acts to maintain a preload in kidney-shaped pipes 6a and 6b with an outward bias. A CT Spiral Taping Machine 52 may be used to wrap either adhesive or non-adhesive tapes on kidney-shaped pipes 6a and 6b prior to insertion of kidney-shaped pipes 6a, 6b into bore 45. Often the taping head is mounted proximal to a Cat-track pusher 53 near the proximal end of bore 45. The Cat-track pusher 53 is adapted to grab and hold the taped kidney-shaped pipes 6a and 6b, to insert them into bore 45, and can exert up to 600 pounds of force.

Return coupling elbow 8 is assembled to the free ends of kidney-shaped pipes 6a and 6b so as to couple them together. More particularly, the free ends of kidney-shaped pipes 6a and 6b are first treated in a fusion tool 57 which grinds the free ends of kidney-shaped pipes 6a and 6b, heats the ground faces, and then joins the heated faces to correspondingly ground and heated end faces of legs 38 and 40 of return coupling elbow 8 so as to fuse them together. This same process is used to join a new length of both kidney-shaped pipes 6a, 6b so as to further extend the length of loop 2 in bore 45. Once return coupling elbow 8 is affixed to the free ends of kidney-shaped pipes 6a and 6b, so as to form geothermal well loop 2 it is pushed into bore 45. Water 60 often is found in bore 45 after drilling. Water added to central passageway 20 is often used to overcome buoyancy during installation and prevent kidney-shaped pipes 6a and 6b from buckling under pressure while being installed in bore 45.

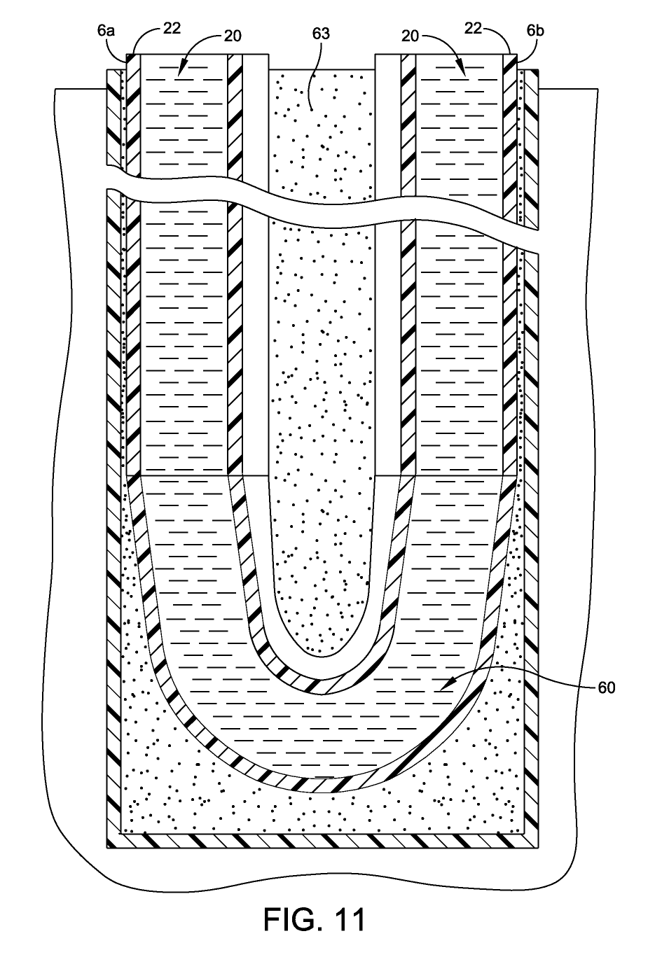

Once, geothermal well loop 2 has been installed within bore 45, a tremie pipe (not shown) may be positioned within passageway 50. Grout 63 is then pumped into passageway 50 and bore 45 (FIG. 11). Grout 63 often contains Portland cement, Bentonite chips and sand to enhance thermal conduction. The pressure from the expanding grout 63, and the stored energy held by the taped kidney-shaped pipes 6a and 6b, combine to overcome frangible tape 51 (or a water soluable glue in other embodiments) weakening or breaking tape 51 and thereby allowing kidney-shaped pipes 6a and 6b to spring apart and separate from one another so as to be radially biases away from one another and into biased engagement with the walls that define bore 45 within the earth. An alternative method employs a blunted tape cutter bar mounted on the exterior of the tremie pipe head that rides in the open space between the loop members. The biased engagement of kidney-shaped pipes 6a and 6b with the walls that define bore 45 is supported by the introduction of grout 63 into passageway 50 and bore 45 thereby increasing the pressure exerted by outer surface 12 of continuous wall 10 against the surface that defines bore 45 so as to increase the efficiency of the thermal transfer of geothermal loop 2 during operation. The biased engagement of kidney-shaped pipes 6a and 6b with the walls that define bore 45 also acts to minimize the possibility of shunting between the pipes.

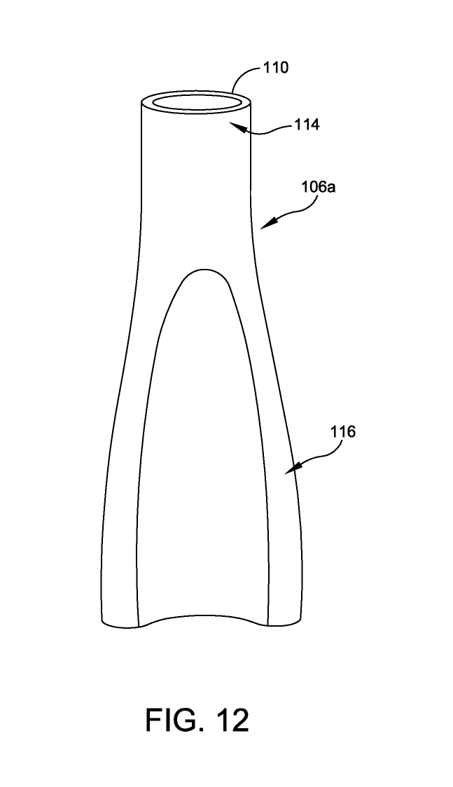

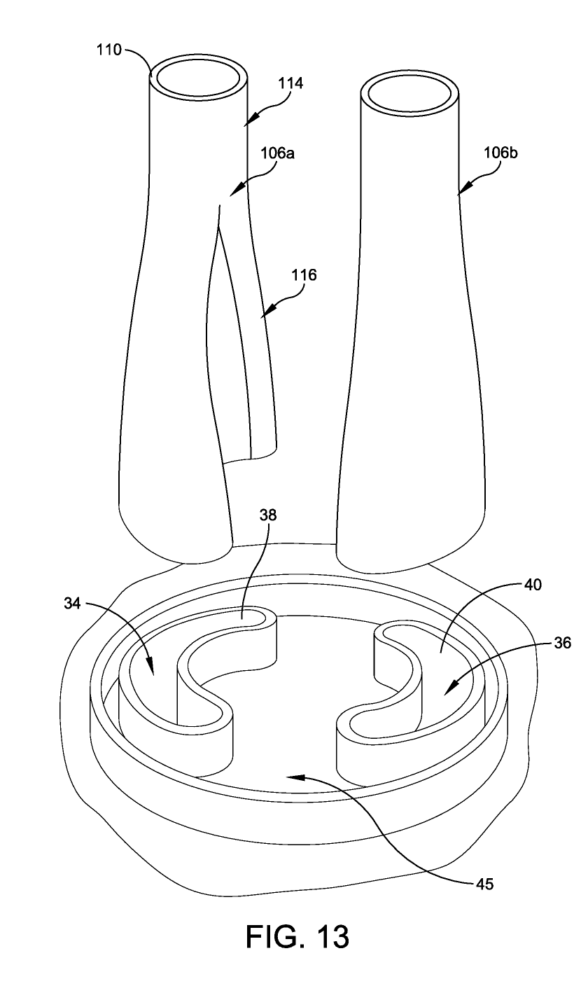

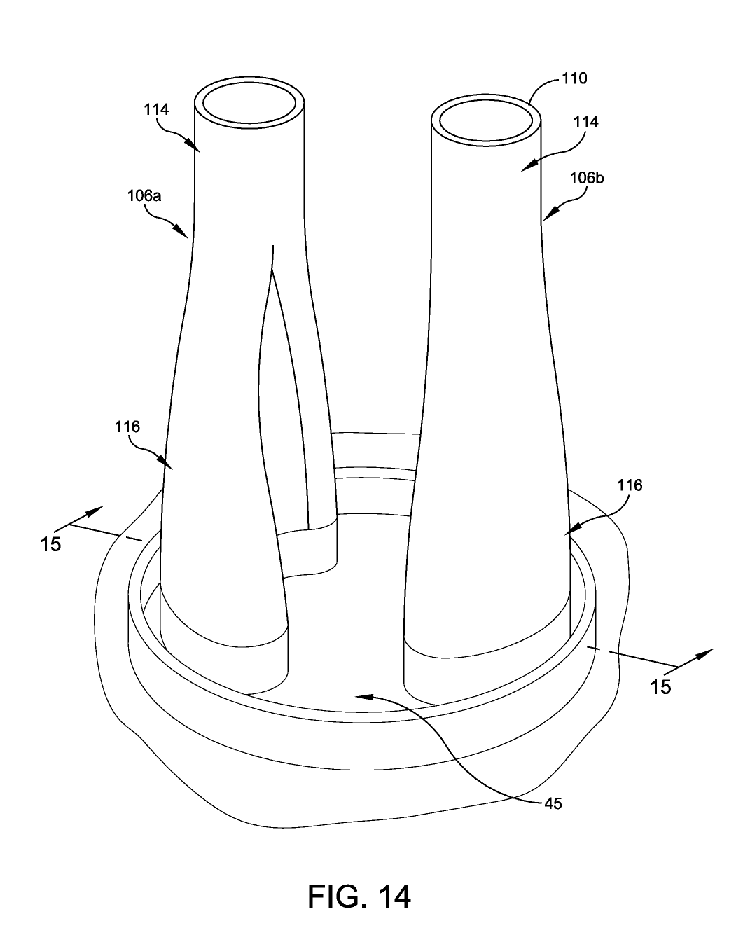

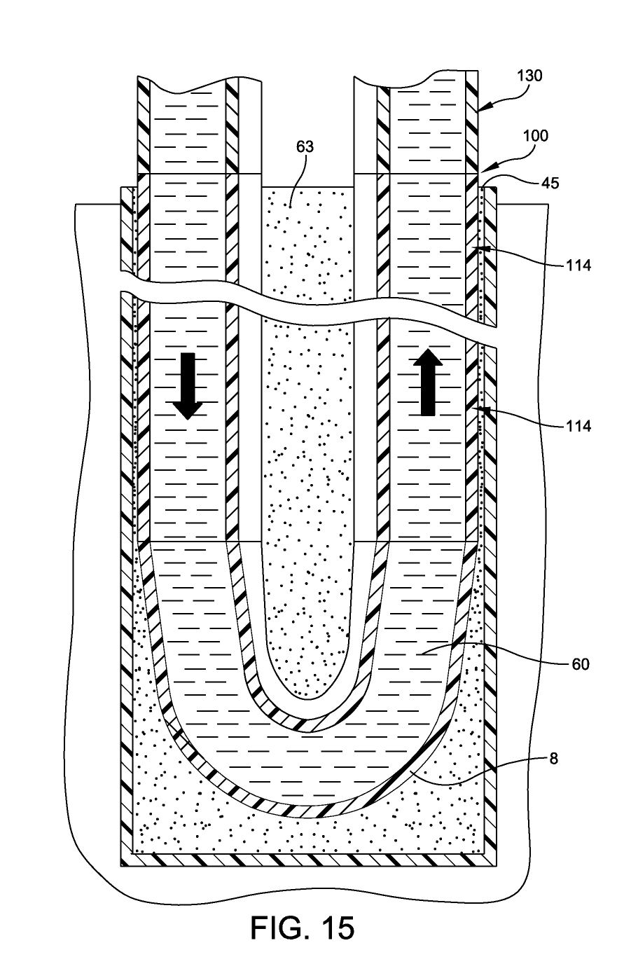

Referring to FIGS. 12-17, an alternative loop 100 includes a first hybrid pipe 106a and a second hybrid pipe 106b. More particularly, each of hybrid pipes 106a and 106b, has an elongate, continuous and resilient wall 110, however unlike kidney-shaped pipes 6a and 6b a proximal portion 114 of each hybrid pipe 106a and 106b comprises a circular cross-section and a distal portion 116 transitions from a circular cross-section to a kidney-shaped cross-section comparable to the cross-section of kidney-shaped pipes 6a and 6b. Hybrid pipes 106a and 106b are also formed from the same HDPE pipe material that is now molded to create the exemplary kidney-shape distal portion 116, while maintaining a circular cross-section in proximal portion 114 more suitable for external joining to lateral distribution piping. Continuous wall 110 often is consistent with standard 1.5 inch DR11 HDPE pipe for joining to lateral distribution piping. Again, HDPE pipe having a wall thickness in this range exhibits sufficient strength to proof test at internal pressures of around 100 psi. An alternate simple U-bend embodiment 8A can be constructed from the hybrid pipe, replacing the return coupling elbow 8 depicted in FIG. 4 with standard 1.5 inch round elbows fused together to form a U-bend. Each end of the U-bend is then fused to the round ends of hybrid pipe 106a and 106b, leaving the free kidney ends to be joined in the field with the kidney pipe 24 as deployed according to 47.

As with kidney-shaped pipes 6a and 6b, hybrid pipe 106a and 106b are formed so as to impart structural preloading to enhance their resilient characteristics. Continuous wall 110 often has a uniform thickness of between about 0.125 inches and about 0.165 inches, with about 0.153 inches often being preferred for applications of the invention. Again, standard 1.5 inch DR11 HDPE pipe having a wall thickness in this range exhibits sufficient strength to survive internal pressures of around 100 psi, while retaining its inherent flexibility and low weight for ease of assembly in the field. As with continuous wall 10, continuous wall 110 is resilient at least in the sense that when deformed or loaded, i.e., bent, stretched, or squashed, it is able to store elastic energy but tends to spring back quickly into its original shape or configuration as the load is being removed.

Return coupling elbow 8 is coupled to the free ends of hybrid pipe 106a and 106b in much the same way as hybrid pipe 106a and 106b. More particularly, the free ends of hybrid pipes 106a and 106b are first treated in a fusion tool 57 which grinds the free ends of hybrid pipe 106a and 106b, heats the ground faces, and then joins the heated faces to correspondingly ground and heated end faces of legs 38 and 40 of return elbow 8 so as to fuse them together. This same process is used to join a length of conventional, circular cross-section pipe to each of hybrid pipe 106a and 106b so as to further extend the length of loop 100 in bore 45. Once return elbow 8 is affixed to the free ends of hybrid pipe 106a and 106b, so as to form geothermal well loop 100 it is pushed into bore 45 in accordance with the methodology previously disclosed in connection with geothermal loop 2.

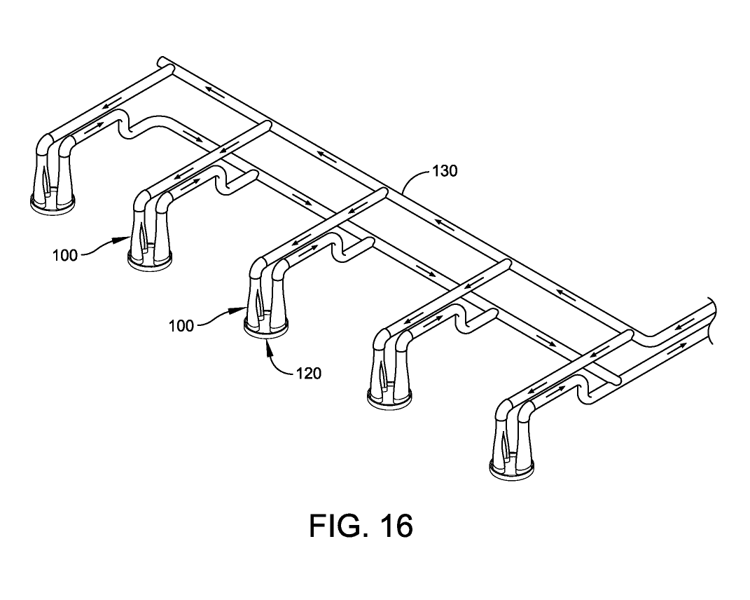

Referring to FIG. 16, the costs of implementing a system of wells 120 is reduced by the use of loop 100 since conventional, circular cross-section pipe 130 may be used to interconnect a plurality of wells 120, while obtaining higher heat transfer benefits associated with the use of kidney-shaped pipes 6a and 6b within the well.

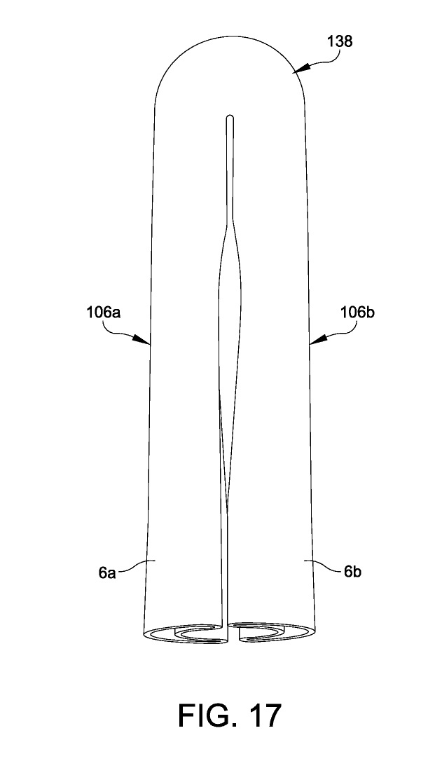

Referring to FIG. 17, in another embodiment of the invention, hybrid pipes 106a and 106b form a transition coupling between a circular cross-section return coupling elbow 138 and kidney-shaped pipes 6a and 6b. Hybrid pipes 106a and 106b, circular cross-section return elbow 138, and kidney-shaped pipes 6a and 6b are assembled to one another to form a loop in the same way as other embodiments of the invention.

While the foregoing description and drawings represent the preferred embodiments of the present invention, it will be understood that various additions, modifications and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed is:

1. A loop suitable for insertion into a bore formed by a surface extending into the earth for use in a geothermal well, the loop comprising:
a first resilient pipe having a proximal end and a distal end and defining a first passageway that communicates between said proximal end and said distal end;
a second resilient pipe having a proximal end and a distal end and defining a second passageway that communicates between said proximal end and said distal end;
a coupling positioned at said distal ends of said first and second resilient pipes, said coupling defining a return passageway arranged so as to communicate between said first passageway and said second passageway;
wherein when said loop is positioned within said bore, said first resilient pipe and said second resilient pipe transition from (i) a bound state in which said first resilient pipe and said second resilient pipe are maintained in contact with one another to, (ii) a released state in which said first resilient pipe and said second resilient pipe are in biased contact with said surface extending into the earth.

2. The loop of claim 1 wherein said first resilient pipe and said second resilient pipe comprise a kidney-shaped cross-sectional profile, each said resilient pipe having an outer surface that comprises an area sufficient to occupy about seventy percent of the area of said surface that defines said bore thereby to enhance heat transfer.

3. The loop of claim 1 wherein said first resilient pipe and said second resilient pipe comprise a proximal portion having a circular cross-section and a distal portion having a kidney-shaped cross-section.

4. The loop of claim 2 wherein said first resilient pipe and said second resilient pipe include radially outwardly disposed outer portion having an outer surface and an inwardly disposed inner portion having an inner surface wherein said outer surfaces are greater in surface area than said inner surfaces.

5. The loop of claim 4 wherein said inner surfaces are arranged in confronting relation to one another so as to defines a central passage way that extends continuously from a first end of said loop to a second end of said loop.

6. The loop of claim 5 wherein said first resilient pipe and said second resilient pipe are formed from high-density polyethylene pipe of minimal thickness to enhance thermal conduction but yet pass 100 psi proof test.

7. The loop of claim 6 wherein said first resilient pipe and said second resilient pipe comprise a continuous longitudinally extending wall having a uniform thickness of between about 0.125 inches and about 0.135 inches.

8. The loop of claim 7 wherein said first resilient pipe and said second resilient pipe store elastic energy when deformed by a load.

9. The loop of claim 1 wherein said coupling comprises an arc extending through approximately 180° and defines a pair of ports that are arranged in flow communication with said first resilient pipe and said second resilient pipe.

10. The loop of claim 9 wherein said bound state comprises said first resilient pipe and said second resilient pipe held together by a frangible tape, whereby said bound state overcomes a residual outward bias in said first resilient pipe and said second resilient pipe such that each of said bound pipes stores elastic energy.

11. The loop of claim 10 wherein said frangible tape is spiral wound along the length of said loop.

12. The loop of claim 11 wherein a period of said wound frangible tape along a length of said loop between fifteen and twenty inches per revolution about said loop.

13. The loop of claim 1 wherein said bound state comprises said first resilient pipe and said second resilient pipe joined together with a water soluble adhesive, whereby said bound state overcomes a residual outward bias in said first resilient pipe and said second resilient pipe such that each of said bound pipes stores elastic energy.

14. A geothermal heat exchange system comprising:
a loop that is suitable for insertion into a bore formed by a surface extending into the earth, said bore having a proximal end and a distal end said loop including a first resilient pipe having a proximal end and a distal end and defining a first passageway that communicates between said proximal end and said distal end, a second resilient pipe having a proximal end and a distal end and defining a second passageway that communicates between said proximal end and said distal end, wherein said first pipe and said second pipe are releasably bound to one another so as to be held in a preloaded state;
a coupling elbow positioned at said distal ends of said first and second resilient pipes, said coupling elbow defining a return passageway arranged so as to communicate between said first passageway and said second passageway;
wherein when said loop is positioned within said bore, said first resilient pipe and said second resilient pipe transition from said bound preloaded state to a released and unbound state in which said first resilient pipe and said second resilient pipe are in biased contact with said surface extending into the earth.

15. The loop of claim 14 wherein each said first resilient pipe and said second resilient pipe is kidney-shaped so as to include a radially outwardly disposed outer portion having an outer surface and an inwardly disposed inner portion having an inner surface wherein said outer surfaces are greater in surface area than said inner surfaces.

16. The loop of claim 14 wherein said first resilient pipe and said second resilient pipe comprise a proximal portion having a circular cross-section and a distal portion having a kidney-shaped cross-section.

17. The loop of claim 15 wherein said inner surfaces are arranged in confronting relation to one another so as to defines a central passage way that extends continuously from a first end of said loop to a second end of said loop.

18. The loop of claim 17 wherein said first resilient pipe and said second resilient pipe are formed from high-density polyethylene of minimal thickness to enhance thermal conduction but yet pass 100 psi proof test.

19. The loop of claim 18 wherein said first resilient pipe and said second resilient pipe comprise a continuous longitudinally extending wall having a uniform thickness of between about 0.125 inches and about 0.135 inches.

20. The loop of claim 19 wherein said first resilient pipe and said second resilient pipe store elastic energy when deformed by a load.

21. The loop of claim 14 wherein said coupling comprises an arc extending through approximately 180° and defines a pair of ports that are arranged in flow communication with said first resilient pipe and said second resilient pipe.

22. The loop of claim 21 wherein said bound state comprises said first resilient pipe and said second resilient pipe held together by a frangible tape, whereby said bound state overcomes a residual outward bias in said first resilient pipe and said second resilient pipe such that each of said bound pipes stores elastic energy.

23. The loop of claim 22 wherein said frangible tape is spiral wound along the length of said loop.

24. The loop of claim 23 wherein a period of said wound frangible tape along a length of said loop between fifteen and twenty inches per revolution about said loop.

25. The loop of claim 14 wherein said bound state comprises said first resilient pipe and said second resilient pipe joined together with a water soluble adhesive, whereby said bound state overcomes a residual outward bias in said first resilient pipe and said second resilient pipe such that each of said bound pipes stores elastic energy.

26. A method for locating a geothermal loop within a bore formed by a surface extending into the earth, said bore having a proximal end and a distal end, comprising the steps of:
(A) releasably binding together a first resilient pipe to a second resilient pipe so as to preload said resilient pipes;
(B) positioning said preloaded resilient pipes within said bore;
(C) unbinding said preloaded resilient pipes so that each resilient pipe springs away from the other resilient pipe and into heat transfer engagement with said surface defining said bore.

27. A method for locating a geothermal loop within a bore according to claim 26 wherein said releasably binding step comprises applying a frangible tape longitudinally along the length of said a first resilient pipe and said second resilient.

28. A method for locating a geothermal loop within a bore according to claim 26 wherein said releasably binding step comprises applying a water soluble adhesive along the length of said a first resilient pipe and said second resilient.

29. A method for locating a geothermal loop within a bore according to claim 26 wherein said releasably binding step comprises applying a spiral of frangible tape longitudinally along the length of said a first resilient pipe and said second resilient, wherein said spiral comprises a period in the range from about fifteen inches to about twenty inches per revolution.

30. A method for locating a geothermal loop within a bore according to claim 27 wherein said releasably binding step is followed by adding a grout to said bore to initiate the release of said frangible tape.
